(19) United States
(12) Patent Application Publication
(10) Pub. No.: US 2012/0203591 A1
(43) Pub. Date: Aug. 9, 2012

(54) SYSTEMS, METHODS, AND APPARATUS FOR DETERMINING PIPELINE ASSET INTEGRITY

(75) Inventors: Kavitha Andoji, Hitec City (IN); Vinoth Kumar Mohan, Hitec City (IN); Ashish Garg, Rajasthan (IN)

(73) Assignee: GENERAL ELECTRIC COMPANY, Schenectady, NY (US)

(21) Appl. No.: 13/023,216

(22) Filed: Feb. 8, 2011

(51) Int. Cl. G06Q 10/00

(52) U.S. Cl. 705/7.28

(57) ABSTRACT

Certain embodiments of the invention may include systems, methods, and apparatus for determining pipeline asset integrity. According to an example embodiment of the invention, a computer executable method is provided for determining integrity of assets. The method can include identifying one or more risk factor conditions associated with one or more assets; evaluating the one or more risk factor conditions associated with the one or more assets; assigning non-linear weighted values to the one or more risk factor conditions based at least in part on evaluating the one or more risk factor conditions; determining one or more risk scores for the one or more assets based at least in part on the non-linear weighted values; and outputting the one or more risk scores.

### FIELD OF THE INVENTION

This invention generally relates to pipeline integrity, and in particular, to systems, methods, and apparatus for determining pipeline asset integrity.

### BACKGROUND OF THE INVENTION

Utility companies often utilize pipelines to protect and/or deliver their product to customers. For example, fluids (such as water) or gases (such as natural gas) may be delivered to customers via a pipeline system that may include regulators, meters, valves, safety components, etc. Pipelines may also be used to protect cables and wires for delivery of electricity, phone, cable TV, and internet connections. Since the pipelines are often exposed to elements, buried underground, or otherwise used in harsh environments, the pipelines and associated components may deteriorate or become damaged, causing utility interruptions, costly repairs, and safety hazards. Many customers may be affected or even subjected to emergency measures when critical pipelines malfunction.

To address the risks associated with pipelines, utilities are often required by regulators to assess and manage such risks. The assessments are typically done manually based on available data, and they usually require field technicians with extensive knowledge and experience.

### BRIEF SUMMARY OF THE INVENTION

Some or all of the above needs may be addressed by certain embodiments of the invention. Certain embodiments of the invention may include systems, methods, and apparatus for determining pipeline asset integrity.

According to an example embodiment of the invention, a method is provided for determining integrity of assets, The method includes identifying risk factor conditions associated with one or more assets. The method may include identifying one or more risk factor conditions associated with one or more assets; evaluating the one or more risk factor conditions associated with the one or more assets; assigning non-linear weighted values to the one or more risk factor conditions based at least in part on evaluating the one or more risk factor conditions; determining one or more risk scores for the one or more assets based at least in part on the non-linear weighted values; and outputting the one or more risk scores.

According to another example embodiment, a system is provided for determining integrity of pipeline assets. The system may include a geographic information system (GIS) database; a display; at least one processor in communication with the display and the GIS database. The at least one processor may be configured for: identifying one or more risk factor conditions associated with one or more pipeline assets; evaluating the one or more risk factor conditions associated with the one or more pipeline assets; assigning non-linear weighted values to the one or more risk factor conditions based at least in part on evaluating the one or more risk factor conditions; determining one or more risk scores for the one or more pipeline assets based at least in part on the non-linear weighted values; and outputting the one or more risk scores.

According to another example embodiment, an apparatus is provided for determining integrity of pipeline assets. The apparatus may include at least one processor in communication with a geographic information system (GIS) database. The at least one processor may be configured for: identifying one or more risk factor conditions associated with one or more pipeline assets; evaluating the one or more risk factor conditions associated with the one or more pipeline assets; assigning non-linear weighted values to the one or more risk factor conditions based at least in part on evaluating the one or more risk factor conditions; determining one or more risk scores for the one or more pipeline assets based at least in part on the non-linear weighted values; and outputting the one or more risk scores.

Other embodiments and aspects of the invention are described in detail herein and are considered a part of the claimed invention. Other embodiments and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a block diagram of an illustrative pipeline integrity prediction system, according to an example embodiment of the invention.

FIG. 2 is a block diagram of an illustrative graphical information system, according to an example embodiment of the invention.

FIG. 3 is a flow diagram of an example method according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain embodiments of the invention may enable pipeline utility companies to make better-informed decisions for maintaining and repairing their pipeline assets. Example embodiments of the invention may include a geographic information system (GIS) pipeline integrity prediction system that may provide a tool to determine the pipeline risk based on the likelihood of failure, and/or the consequence of such failures. Embodiments of the system can provide user-defined optional and default parameters, geographical map selection, and tools to visualize the pipeline most at risk. According to example embodiments, the GIS pipeline integrity prediction system may receive information from a GIS database to identify each asset, to identify weak assets, and/or to identify and rank assets according to risks. Common factors and weak factors may be evaluated and assessed. For example, factors taken into consideration may include structural factors such as age of the pipe, material of the pipe, maximum allowable operating pressure, and third party networks. In example embodiments, environmental factors including soil pH values and weather may also be taken into consideration. These common factors may be used to rate the assets for risk of failure.

According to an example embodiment, additional factors may be assessed, including fault history, for example, leaks, corrosion rate, and rupture. In certain embodiments, the pipeline assets may be prioritized with respect to the severity of the fault history and/or the determined risk. In an example embodiment, maintenance and/or inspection of the assets may be prioritized based on the information derived from the pipeline integrity prediction system. For example, a user may inspect assets that are identified with a high severity and/or consequence basis. In certain embodiments, a high consequence factors may include customer impact and costs. For example, the cost of immediately repairing or replacing an asset may be relatively low, but if left unchecked, could create a catastrophic failure. In certain example embodiments, additional factors may be considered for assessing the integrity of the pipeline assets, including earthquakes, floods, and other natural calamities. According to certain example embodiments, custom options may allow users to customize or fine-tune the behavior of the assessment by adding rules and/or requirements.

According to certain example embodiments the GIS pipeline integrity prediction system (GPIPS) may be utilized to evaluate pipeline risk based on factors configured by the pipeline operators. For example, the pipeline risk may be defined in terms of probability of the failures and the consequences of such failure. According to example embodiments, risk factors for evaluating pipeline asset risk may include, but are not limited to, risk of failure, failure consequence risk, failure due to environmental factors, fault history, criticality, inspection status, age, material, maximum operating pressure, soil pH, weather conditions, leaks, corrosion rate, rupture rate, reliability, lifetime, durability, known conditions, environment, test results and/or adverse affects associated with outage.

According to example embodiments, evaluating the one or more risk factor conditions may include receiving pipeline asset information and risk factor information from a geographic information system (GIS) database. In an example embodiment, resources may be prioritized based at least in part on determining one or more risk scores, where the risk scores for the one or more pipeline assets may be based at least in part on non-linear weightings. In an example embodiment, and to illustrate the concept of the non-linear weightings, one pipeline section may be between about 3 and about 5 years old, and another section may be between about 13 and about 15 years old. A weighting, for example, of 3 to 5 may be assigned to the 3 to 5 year old pipeline, but a weighting of 30 to 60 may be applied to the section that is between 13 and 15 years old. Other examples of assigning non-linear weightings can be made according to example embodiments. For example, one asset may be in a rural area with sparse population, and another identical asset may be located in a crowded metropolitan area, where failure may affect an entire section of a city if it were to fail. In this example, the asset in the metropolitan area may be assigned a much greater weighting due to the risk of outage associated with it as compared to the asset in the rural area.

According to example embodiments, weightings assigned to one risk factor may be influenced by one or more other risk factors. For example, risk factors for assets made from certain materials may be influenced by the age of the asset.

In certain example embodiments, determining and outputting one or more risk scores may be based on sorting the pipeline assets by a sum of the non-linear weighted values associated with the one or more risk factor conditions. Such an example embodiment may serve to prioritize the asset inspection, repair, and/or replacement. For example, a higher risk score may correspond to a greater risk of failure or a greater potential consequence. According to example embodiments, predicting a lifetime of the one or more pipeline assets may be based at least in part on the one or more risk factor conditions.

In certain embodiments, a GIS tool may be utilized to query the GIS databases by using the different combinations of attributes. In an example embodiment, the GIS tool may be designed to query or receive the input of geographic map selection or the entire geographic database, scan each asset, and estimate the risk accordingly. In an example embodiment, the GIS tool may assess the likelihood of failure based around pipeline threats or risks. For example, pipeline threats or risks may include, but are not limited to, factors such as external corrosion, internal corrosion, third party damage, stress corrosion cracking, manufacturing defects, construction defects, equipment failure, incorrect operation, and weather related ground movement.

According to example embodiments of the inventions, a GIS tool and database may be utilized to identify faulty assets by storing and monitoring risk or threat factor records associated with the assets. For example, according to certain embodiments, risk or threat factor records may include, but are not limited to, external or internal corrosion, leaks, material types, soil pH, soil type, soil stability, whether the asset is exposed, asset accessibility, joints, welds, age, materials, inspection trends, and/or time between inspections.

According to example embodiments, a GIS pipeline integrity prediction system (GPIPS) may be utilized to estimate asset likelihood of failure, estimate consequence of failure, calculate pipeline risk using likelihood and consequence of failure, display tabular or visual representation on a map, and generate and send a report to assist operators to make maintenance decisions (via e-mail, SMS, etc). According to example embodiments, the GPIPS may identify needs for manual efforts in determining the weak assets. In an example embodiment, the GPIPS may provide information that may direct resources and expenses to the right asset at the right time. Example embodiments may further keep track of weak assets.

Various databases, controllers, networks, processors, and data sources to predict the integrity of pipeline assets, according to example embodiments of the invention, will now be described with reference to the accompanying figures.

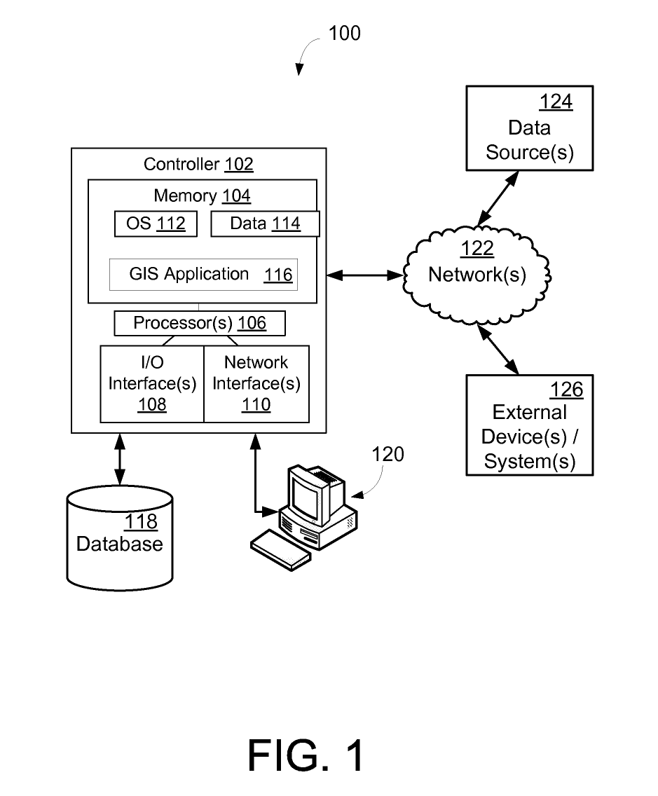

FIG. 1 illustrates an example GIS enabled pipeline evaluation system 100. According to an example embodiment of the inventions, the system 100 may include a controller 102, one or more databases 118, one or more networked or local computers or workstations 120, one or more networks 122, one or more data sources 123, and/or one or more external devices or systems 126 in communication with the network 122. In an example embodiment, the controller 102 may include a memory 104, one or more processors 106, one or more input/output interfaces, and/or one or more network interfaces 110. In an example embodiment, the memory may include an operating system 112, data 114, and one or more GIS application modules 116 in communication with the one or more processors 106. The one or more GIS application modules 116 may receive data from the database 118, local data 114 stored in the memory 104, or data from external data sources 124 via one or more networks 122. Data may also be provided via the network 122 from external devices or systems 126.

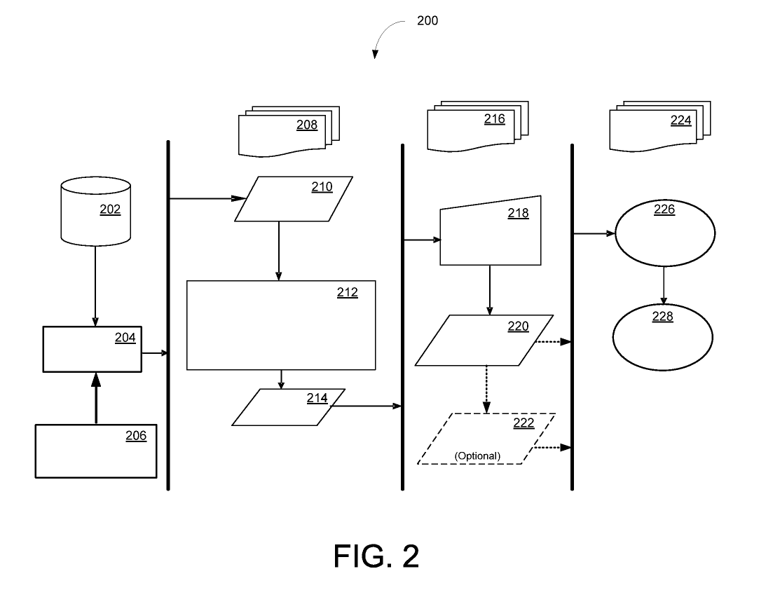

FIG. 2 illustrates an example pipeline evaluation process GIS application 200, according to example embodiments of the invention. In an example embodiment, data from a GIS database 202 may provide input for a GIS tool 204. The GIS tool 204, for example, may include a graphical user interface, or operator controlled or automatic means for input, output, and viewing representation of data. According to an example embodiment of the invention, the GIS tool 204 may receive input attributes 206 for processing the data from the GIS database 202. According to an example embodiment, assets corresponding to the input attributes 206 may be assessed 208 for fault risk based on various risk factors, location, etc. In an example embodiment, pipeline assets 210 may be scanned and evaluated for fault trends. According to an example embodiment, the assets 210 may be graded for risk factor conditions 212, and such risk factor conditions may be stored and trended over time to determine a risk fault score 214. According to example embodiments of the invention, the risk fault score 214 may be utilized to assess or predict 216 the lifetime remaining on the asset before a fault occurs.

In an example embodiment, pipeline assets may be rated to determine the risk based on one or more fault risks 214. In an example embodiment, the pipeline assets may be prioritized 220 based on the rated risk 218 so that resources (manpower, money, etc.,) may be appropriately allocated to repair or replace the pipeline assets. According to an example embodiment, an option consequences filter 222 may be used to further assess and/or refine and/or prioritize the assets in terms of the potential consequences of failure.

According to an example embodiment of the invention, information related to the prioritized assets may further be utilized by a post prediction process 224. For example, the post prediction process 224 may provide information that the asset should be designated for inspection and/or maintenance 226. In another example embodiment, the post prediction process 224 may indicate that planning and remediation 228 is appropriate for the particular assets.

According to example embodiments of the inventions, a certain order of operations for evaluating assets for risk scores may be implemented to leverage certain efficiencies. For example, information in a GIS database may include stored risk factors for numerous assets, and the asset information for each pipeline may be scanned and looped to evaluate faults. For example, each asset may be evaluated and assigned weightings for various levels (high, medium, low, and severity, for example) for the following factors: if it has been inspected; its age; the material it is made from; the maximum operating pressure; the soil conditions such as pH; weather conditions; whether the asset has leaks; the corrosion rate of the asset; and the rupture rate. According to an example embodiment, the consequence filter 222 may either be bypassed (for example, if the asset is just a single pipe going to a single customer's location), or it may be utilized to determine adverse affects of an outage (for example, if the asset is in a public or highly populated area). In an example embodiment, the asset values may be sorted according to a sum of the asset risk weightings, and each of the sorted assets may be added to a maintenance and inspection table that may rank the severity of the assets for further action.

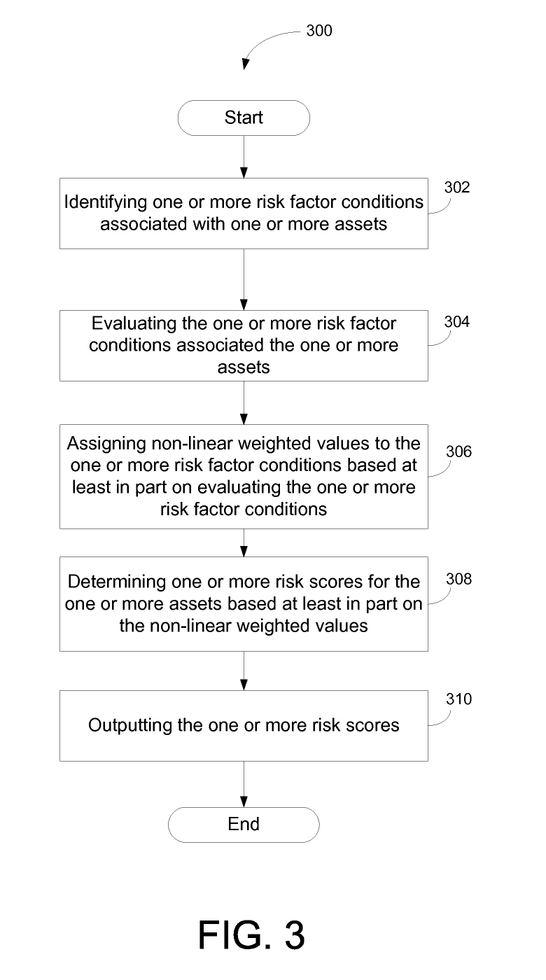

An example method 300 determining integrity of assets will now be described with reference to the flowchart of FIG. 3. The method 300 starts in block 302 and may include identifying risk factor conditions associated with one or more assets. In block 304, the method 300 may include evaluating the risk factor conditions of the one or more assets. In block 306, the method 300 may include assigning non-linear weighted values to the risk factor conditions based at least in part on evaluating the risk factor conditions. In block 308, the method 300 may include determining a risk score for the one or more assets based at least in part on the weighted values. In block 310, the method 300 may include outputting the risk scores. The method 300 ends in block 310. According to an example embodiment, the assets may be associated with a pipeline.

Accordingly, example embodiments of the invention can provide the technical effects of creating certain systems, methods, and apparatus that provide reliable compliance procedures. Example embodiments of the invention can provide the further technical effects of providing systems, methods, and apparatus for providing prediction of failure for pipeline assets and allocating resources to circumvent costly failures.

In example embodiments of the invention, the GIS enabled pipeline evaluation system 100 may include any number of hardware and/or software applications that are executed to facilitate any of the operations.

In example embodiments, one or more I/O interfaces may facilitate communication between the GIS enabled pipeline evaluation system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the GIS enabled pipeline evaluation system 100. The one or more I/O interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the GIS enabled pipeline evaluation system 100 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (Owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the invention may include the GIS enabled pipeline evaluation system 100 and the pipeline evaluation process GIS application 200 with more or less of the components illustrated in FIGS. 1 and 2.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A computer executable method for determining integrity of assets comprising:
identifying one or more risk factor conditions associated with one or more assets;
evaluating the one or more risk factor conditions associated with the one or more assets;
assigning non-linear weighted values to the one or more risk factor conditions based at least in part on evaluating the one or more risk factor conditions;
determining one or more risk scores for the one or more assets based at least in part on the non-linear weighted values; and
outputting the one or more risk scores.

2. The method of claim 1, wherein the one or more risk factor conditions comprise one or more of: risk of failure, failure consequence risk, failure due to environmental factors, fault history, criticality, inspection status, age, material, maximum operating pressure, soil pH, weather conditions, leaks, corrosion rate, rupture rate, reliability, lifetime, durability, known conditions, environment, test results or adverse affects associated with outage.

3. The method of claim 1, wherein evaluating the one or more risk factor conditions comprises receiving pipeline asset information and risk factor information from a geographic information system (GIS) database.

4. The method of claim 1 further comprising prioritizing resources based at least in part on determining the one or more risk scores.

5. The method of claim 1, wherein outputting the one or more risk scores comprises sorting the assets by a sum of the non-linear weighted values associated with the one or more risk factor conditions.

6. The method of claim 1, wherein a higher risk score corresponds to one or more of a greater risk of failure or a greater potential consequence.

7. The method of claim 1, further comprising predicting a lifetime of the one or more assets based at least in part on the one or more risk factor conditions.

8. A system for determining integrity of pipeline assets comprising:
a geographic information system (GIS) database (118);
a display (120);
at least one processor (106) in communication with the display (120) and the GIS database (118), and configured for:
identifying one or more risk factor conditions associated with one or more pipeline assets;
evaluating the one or more risk factor conditions associated with the one or more pipeline assets;
assigning non-linear weighted values to the one or more risk factor conditions based at least in part on evaluating the one or more risk factor conditions;
determining one or more risk scores for the one or more pipeline assets based at least in part on the non-linear weighted values; and
outputting the one or more risk scores to the display (120).

9. The system of claim 8, wherein the one or more risk factor conditions comprise one or more of: risk of failure, failure consequence risk, failure due to environmental factors, fault history, criticality, inspection status, age, material, maximum operating pressure, soil pH, weather conditions, leaks, corrosion rate, rupture rate, reliability, lifetime, durability, known conditions, environment, test results or adverse affects associated with outage.

10. The system of claim 8, wherein evaluating the one or more risk factor conditions comprises receiving pipeline asset information and risk factor information from a geographic information system (GIS) database.

11. The system of claim 8, further comprising prioritizing resources based at least in part on determining the one or more risk scores.

12. The system of claim 8, wherein outputting the one or more risk scores comprises sorting the pipeline assets by a sum of the non-linear weighted values associated with the one or more risk factor conditions.

13. The system of claim 8, wherein a higher risk score corresponds to one or more of a greater risk of failure or a greater potential consequence.

14. The system of claim 8, wherein the at least one processor (106) is further configured for predicting a lifetime of the one or more pipeline assets based at least in part on the one or more risk conditions.

15. An apparatus for determining integrity of pipeline assets comprising:
at least one processor (106) in communication with a geographic information system (GIS) database (118), and configured for:
identifying one or more risk factor conditions associated with one or more pipeline assets;
evaluating the one or more risk factor conditions associated with the one or more pipeline assets;
assigning non-linear weighted values to the one or more risk factor conditions based at least in part on evaluating the one or more risk factor conditions;
determining one or more risk scores for the one or more pipeline assets based at least in part on the non-linear weighted values; and
outputting the one or more risk scores to the display (120).

16. The apparatus of claim 15, wherein the one or more risk factor conditions comprise one or more of: risk of failure, failure consequence risk, failure due to environmental factors, fault history, criticality, inspection status, age, material, maximum operating pressure, soil pH, weather conditions, leaks, corrosion rate, rupture rate, reliability, lifetime, durability, known conditions, environment, test results or adverse affects associated with outage.

17. The apparatus of claim 15, wherein evaluating the one or more risk factor conditions comprises receiving pipeline asset information and risk factor information from a geographic information system (GIS) database.

18. The apparatus of claim 15, further comprising prioritizing resources based at least in part on determining the one or more risk scores.

19. The apparatus of claim 15, wherein outputting the one or more risk scores comprises sorting the pipeline assets by a sum of the non-linear weighted values associated with the one or more risk factor conditions.

20. The apparatus of claim 15, wherein the at least one processor (106) is further configured for predicting a lifetime of the one or more pipeline assets based at least in part on the one or more risk conditions.
